(19) United States
(12) Patent Application Publication
(10) Pub. No.: US 2026/0007915 A1
(43) Pub. Date: Jan. 8, 2026

(54) CENTER BRACKET FOR SPRINKLER

(71) Applicant: DONGWOO FLEXIBLE METAL TUBE CO., LTD, Namyangju-si (KR)

(72) Inventor: Myeong Yeol SEO, Namyangju-si (KR)

(21) Appl. No.: 18/941,778

(22) Filed: Nov. 8, 2024

(30) Foreign Application Priority Data
Jul. 5, 2024 (KR) 10-2024-0088927

(51) Int. Cl. A62C 35/68

(52) U.S. Cl. CPC A62C 35/68

(57) ABSTRACT

Provided is a center bracket for a sprinkler that stably supports and protects a flexible pipe for a sprinkler, is easy to install, maintains the flexibility of a flexible pipe, increases reliability and durability of a sprinkler system, reduces the costs for maintenance, and secures stable performance even in long-time use.

### CROSS REFERENCE TO RELATED APPLICATION

The present application claims priority to Korean Patent Application No. 10-2024-0088927 filed on Jul. 5, 2024, the entire contents of which are incorporated herein for all purposes by this reference.

### BACKGROUND

### Technical Field

The present disclosure relates to a center bracket for a sprinkler and, in more detail, to a center bracket for a sprinkler that includes a base frame, a front frame, a rear frame, a finish frame, and a fixing member and is simply installed to stably maintain a fire prevention pipeline system by effectively supplying and protecting a flexible pipe of a sprinkler system disposed in a ceiling.

### Description of the Related Art

In general, a sprinkler system, which is a system that suppresses and controls a fire by spraying water when a fire occurs, is generally used for residential buildings, large buildings, commercial facilities, industrial facilities, etc. Such sprinkler systems are installed in a ceiling and prevent spread of fire by quickly responding and spraying water when a fire occurs. One of the important components of sprinkler systems is a flexible pipe and the flexible pipes are connected to sprinkler heads and supply water. Various kinds of brackets were used in sprinkler systems to support and protect flexible pipes in the related art.

However, existing brackets are often cumbersome to install and do not adequately protect flexible pipelines. In particular, when a pipeline is exposed to external shock or vibration, there is a risk of damage to the pipeline or leakage of water. Further, existing brackets do not adequately consider the flexibility of pipes, so pipes may be damaged by brackets in expansion and contraction. Accordingly, it is required to effectively absorb contraction and expansion of a pipe accompanying temperature variation and increase and decrease of water pressure generated by a pump by maintaining the flexibility of a flexible pipe. This can contribute to increasing the durability of a flexible pipe, to reducing the costs for maintenance of sprinklers and a related pipeline system even in long-time use by reducing damage to a flexible pipe that is used for a long time, and to increasing the entire lifespan.

Accordingly, there is a need for an improved bracket that can effectively support and protect a flexible pipe of a sprinkler system. The present disclosure has been made in an effort to solve these problems and provides a center bracket of a new structure that can maintain the flexibility of a flexible pipe while stably supporting the pipe.

### SUMMARY

An objective of the present disclosure is, in order to solve the problems and necessities described above, to provide a center bracket for a sprinkler that stably supports and protects a flexible pipe for a sprinkler, is easy to install, maintains the flexibility of a flexible pipe, increases reliability and durability of a sprinkler system, reduces the costs for maintenance, and secures stable performance even in long-time use.

Another objective of the present disclosure is to provide a center bracket for a sprinkler in which a base frame is configured to surround a first outer circumferential region that is ¼ region of 360° of the outer circumferential surface of a flexible pipe for a sprinkler that surrounds a frame bar on three surfaces along the length of the frame bar, which is disposed in parallel with a ceiling to support the flexible pipe having a cylindrical outer circumference, and is disposed perpendicularly to the length of the frame bar; a front frame protrudes forward further than the frame bar from the front end of the base frame and is configured to surround and support a second outer circumferential region of the flexible pipe; and a rear frame protrudes forward further from the frame bar from the rear end of the base frame, is disposed in parallel with the front frame, is configured to surround a third outer circumferential region facing the second outer circumferential region of the flexible pipe, whereby a frame bar attached to a ceiling and a flexible pipe are firmly supported.

Another objective of the present disclosure is to provide a center bracket for a sprinkler that is simply fixed and fastened by: a finish frame that is fixed to a rotary member disposed at the end of the rear frame and is configured to cover the portion between the front frame and the rear frame and surround a fourth outer circumferential region facing the first outer circumferential region of the flexible pipe; and a fixing member that is configured such that the finish frame is fixed to the front frame through a second finish hole formed at the end of the finish frame and a first finish hole formed at the front end of the front frame.

Another objective of the present disclosure is to provide a center bracket for a sprinkler having increased resistance against vibration and shaking of a flexible pipe because: the base frame has a base bottom surface, and a first base wing surface and a second base wing surface facing each other up and down, and three surfaces of the frame bar are in contact with inner surfaces of the base bottom surface, the first base wing surface, and the second base wing surface; the front frame is formed such that a first front frame surface and a second front frame surface formed by forward extension of the first base wing surface and the second base wing surface face each other, a front frame finish surface is disposed ahead of the first and second front frame surfaces, and the first finish hole is formed at a center of the front frame finish surface; the rear frame is formed such that a first rear frame surface and a second rear frame surface formed by forward extension of the first base wing surface and the second base wing surface face each other, rear frame curved lines are formed at ends of the first and second rear frame surfaces, and rotation through-holes are formed at the first and second rear frame surfaces adjacent to the rear frame curved lines; and the finish frame has a finish bottom surface at a center to press a fourth outer circumferential region of the flexible pipe by covering the portion between the front frame and the rear frame by rotating while surrounding the first and second front frame surfaces and the first and rear frame surfaces, and a first finish surface and a second finish surface are disposed to face each other at the left and right sides of the finish bottom surface such that ends of the first and second finish surfaces cover sides of the first and second front frame surfaces and a top of the front frame finish surface.

Another objective of the present disclosure is to provide a center bracket for a sprinkler that can be fastened for a long time because the fixing member has a fixing body that is inserted into the first and second finish holes when the finish frame is rotated and covers the top of the front frame finish surface, and a fixing head that is connected to a top of the fixing body; and rotation extensions are formed at the left and right of the fixing head, a driver-fixing center groove is formed in a straight line shape or a cross shape at a center, a plurality of anti-rotation protrusions is formed on a bottom of the fixing head, and a second anti-rotation fine friction portions is formed on the finish bottom surface that is in contact with the anti-rotation protrusion.

Another objective of the present disclosure is to provide a center bracket for a sprinkler of which the firmness is increased because: fine friction surfaces are formed on the inner surfaces of the first and second base wing surfaces and the base bottom surface of the base frame and three surfaces of the frame bar are in contact with the fine friction surfaces; and the front frame finish surface having the first finish hole has a first front finish surface bending from the first front frame surface and a second front finish surface bending from the second front frame surface, and first threads are formed on an inner circumferential surface of the first finish hole to be thread-fastened with the fixing body.

The technical subject to implement in the present disclosure is not limited to the technical problems described above and other technical subjects that are not stated herein will be clearly understood by those skilled in the art from the following specifications.

In order to achieve the objectives described above, a center bracket for a sprinkler related to an example of the present disclosure may include a base frame configured to surround a first outer circumferential region that is ¼ region of 360° of an outer circumferential surface of a flexible pipe for a sprinkler that surrounds a frame bar on three surfaces along a length of the frame bar, which is disposed in parallel with a ceiling to support the flexible pipe having a cylindrical outer circumference, and is disposed perpendicularly to the length of the frame bar.

Further, the center bracket may include a front frame protruding forward further than the frame bar from a front end of the base frame and configured to surround and support a second outer circumferential region of the flexible pipe.

In this configuration, the center bracket may include a rear frame protruding forward further from the frame bar from a rear end of the base frame, disposed in parallel with the front frame, configured to surround a third outer circumferential region facing the second outer circumferential region of the flexible pipe.

Further, the center bracket may include a finish frame fixed to a rotary member disposed at an end of the rear frame and configured to cover a portion between the front frame and the rear frame and surround a fourth outer circumferential region facing the first outer circumferential region of the flexible pipe.

Further, the center bracket may include a fixing member configured such that the finish frame is fixed to the front frame through a second finish hole formed at an end of the finish frame and a first finish hole formed at the front end of the front frame.

In this configuration, the base frame may have a base bottom surface, and a first base wing surface and a second base wing surface facing each other up and down, and three surfaces of the frame bar may be in contact with inner surfaces of the base bottom surface, the first base wing surface, and the second base wing surface.

In this configuration, the front frame may be formed such that a first front frame surface and a second front frame surface formed by forward extension of the first base wing surface and the second base wing surface face each other, a front frame finish surface is disposed ahead of the first and second front frame surfaces, and the first finish hole is formed at a center of the front frame finish surface.

Further, the rear frame may be formed such that a first rear frame surface and a second rear frame surface formed by forward extension of the first base wing surface and the second base wing surface face each other, rear frame curved lines may be formed at ends of the first and second rear frame surfaces, and rotation through-holes may be formed at the first and second rear frame surfaces adjacent to the rear frame curved lines.

Further, the finish frame may have a finish bottom surface at a center to press a fourth outer circumferential region of the flexible pipe by covering the portion between the front frame and the rear frame by rotating while surrounding the first and second front frame surfaces and the first and rear frame surfaces, and a first finish surface and a second finish surface may be disposed to face each other at the left and right sides of the finish bottom surface such that ends of the first and second finish surfaces cover sides of the first and second front frame surfaces and a top of the front frame finish surface.

Meanwhile, the fixing member may have a fixing body that is inserted into the first and second finish holes when the finish frame is rotated and covers the top of the front frame finish surface, and a fixing head that is connected to a top of the fixing body.

In this configuration, rotation extensions may be formed at the left and right of the fixing head, a driver-fixing center groove may be formed in a straight line shape or a cross shape at a center, a plurality of anti-rotation protrusions may be formed on a bottom of the fixing head, and a second anti-rotation fine friction portions may be formed on the finish bottom surface that is in contact with the anti-rotation protrusion.

In this configuration, fine friction surfaces may be formed on the inner surfaces of the first and second base wing surfaces and the base bottom surface of the base frame and three surfaces of the frame bar may be in contact with the fine friction surfaces.

Further, the front frame finish surface having the first finish hole may have a first front finish surface bending from the first front frame surface and a second front finish surface bending from the second front frame surface, and first threads may be formed on an inner circumferential surface of the first finish hole to be thread-fastened with the fixing body.

In this configuration, the first front finish surface and the second front finish surface may form layers by coming in contact with each other to increase rigidity of the front frame, a fine accommodation groove may be formed at a lower end of the first front finish surface, and a fine accommodation protrusion that is inserted in the fine accommodation groove may be further formed at an upper end of the second front finish surface, thereby maximizing a contact area of the first front finish surface and the second front finish surface and improving fastening force.

Meanwhile, assistant curved grooves may be formed at center positions of widths of the first and second front frame surfaces and the first and rear frame surfaces.

Further, a shock-absorbing cap made of synthetic resin and curved in correspondence to an outer circumference of the flexible pipe may be disposed at a position where the shock-absorbing cap is in contact with the base frame, the front frame, the rear frame, the finish frame, and the flexible pipe and surrounds the first to fourth outer circumferential regions, and cap protrusions may be formed at an end of the shock-absorbing cap.

In this configuration, the front frame may have an assistant front surface coupling the first front frame surface and the second front frame surface to each other, and the rear frame may have an assistant rear surface coupling the first rear frame surface and the second rear frame surface to each other.

In this configuration, second threads may be formed on the assistant front surfaces and an end of the fixing body may be fastened thereto, whereby an end of the fixing member may be fastened to the first threads and the other end is fastened to the second threads.

Accordingly, the present disclosure has an effect that, by providing a center bracket for a sprinkler, a flexible pipe for a sprinkler is stably supported and protected, installation is easy, the reliability and durability of a sprinkler system are increased by maintaining the flexibility of a flexible pipe, the costs for maintenance are reduced, and stable performance is secured even in long-time use.

Second, a frame bar attached to a ceiling and a flexible pipe are firmly supported by: a base frame configured to surround a first outer circumferential region that is ¼ region of 360° of an outer circumferential surface of a flexible pipe for a sprinkler that surrounds a frame bar on three surfaces along a length of the frame bar, which is disposed in parallel with a ceiling to support the flexible pipe having a cylindrical outer circumference, and is disposed perpendicularly to the length of the frame bar; a front frame protruding forward further than the frame bar from a front end of the base frame and configured to surround and support a second outer circumferential region of the flexible pipe; and a rear frame protruding forward further from the frame bar from a rear end of the base frame, disposed in parallel with the front frame, configured to surround a third outer circumferential region facing the second outer circumferential region of the flexible pipe.

Third, fixing and fastening are simply by: a finish frame fixed to a rotary member disposed at an end of the rear frame and configured to cover a portion between the front frame and the rear frame and surround a fourth outer circumferential region facing the first outer circumferential region of the flexible pipe; and a fixing member configured such that the finish frame is fixed to the front frame through a second finish hole formed at an end of the finish frame and a first finish hole formed at the front end of the front frame.

Fourth, there is an effect that resistance against vibration and shaking of a flexible pipe is increased because: the base frame has a base bottom surface, and a first base wing surface and a second base wing surface facing each other up and down, and three surfaces of the frame bar are in contact with inner surfaces of the base bottom surface, the first base wing surface, and the second base wing surface; the front frame is formed such that a first front frame surface and a second front frame surface formed by forward extension of the first base wing surface and the second base wing surface face each other, a front frame finish surface is disposed ahead of the first and second front frame surfaces, and the first finish hole is formed at a center of the front frame finish surface; the rear frame is formed such that a first rear frame surface and a second rear frame surface formed by forward extension of the first base wing surface and the second base wing surface face each other, rear frame curved lines are formed at ends of the first and second rear frame surfaces, and rotation through-holes are formed at the first and second rear frame surfaces adjacent to the rear frame curved lines; and the finish frame has a finish bottom surface at a center to press a fourth outer circumferential region of the flexible pipe by covering the portion between the front frame and the rear frame by rotating while surrounding the first and second front frame surfaces and the first and rear frame surfaces, and a first finish surface and a second finish surface are disposed to face each other at the left and right sides of the finish bottom surface such that ends of the first and second finish surfaces cover sides of the first and second front frame surfaces and a top of the front frame finish surface.

Fifth, fastening force is maintained for a long time because: the fixing member has a fixing body that is inserted into the first and second finish holes when the finish frame is rotated and covers the top of the front frame finish surface, and a fixing head that is connected to a top of the fixing body; and rotation extensions are formed at the left and right of the fixing head, a driver-fixing center groove is formed in a straight line shape or a cross shape at a center, a plurality of anti-rotation protrusions is formed on a bottom of the fixing head, and a second anti-rotation fine friction portions is formed on the finish bottom surface that is in contact with the anti-rotation protrusion.

Sixth, firmness of the bracket itself is increased because: fine friction surfaces are formed on the inner surfaces of the first and second base wing surfaces and the base bottom surface of the base frame and three surfaces of the frame bar are in contact with the fine friction surfaces; and the front frame finish surface having the first finish hole has a first front finish surface bending from the first front frame surface and a second front finish surface bending from the second front frame surface, and first threads are formed on an inner circumferential surface of the first finish hole to be thread-fastened with the fixing body.

Meanwhile, the effects of the present disclosure are not limited to the effects described above and other effects can be clearly understood by those skilled in the art from the following description.

### BRIEF DESCRIPTION OF THE DRAWINGS

The accompanying drawings of this specification exemplify preferred embodiments and help easy understanding of the present disclosure together with the following detailed description, so the present disclosure should not be construed as being limited to the drawings;

FIG. 1 to FIG. 5 are views showing the entire configuration of a center bracket for a sprinkler according to a preferred embodiment of the present disclosure;

FIG. 6 to FIG. 10 are views showing in more detail the entire configuration of the center bracket for a sprinkler according to a preferred embodiment of the present disclosure;

FIG. 11 to FIG. 13 are views showing in detail a front frame finish surface of the center bracket for a sprinkler according to a preferred embodiment of the present disclosure;

FIG. 14 and FIG. 15 are views showing a shock-absorbing cap of the center bracket for a sprinkler according to a preferred embodiment of the present disclosure;

FIG. 16 and FIG. 17 are views showing a plurality of threads of the center bracket for a sprinkler according to a preferred embodiment of the present disclosure; and

FIG. 18 and FIG. 19 are views showing an assistant curved groove of the center bracket for a sprinkler according to a preferred embodiment of the present disclosure.

### DETAILED DESCRIPTION

Specific structural and functional description about embodiments according to the concept of the present disclosure disclosed herein is exemplified only to describe the embodiments according to the concept of the present disclosure and the embodiments according to the concept of the present disclosure may be implemented in various ways and are not limited to the embodiments described herein.

Embodiments described herein may be changed in various ways and various shapes, so specific embodiments are shown in the drawings and will be described in detail in this specification. However, it should be understood that the exemplary embodiments according to the concept of the present disclosure are not limited to the specific examples, but all of modifications, equivalents, and substitutions are included in the scope and spirit of the present disclosure.

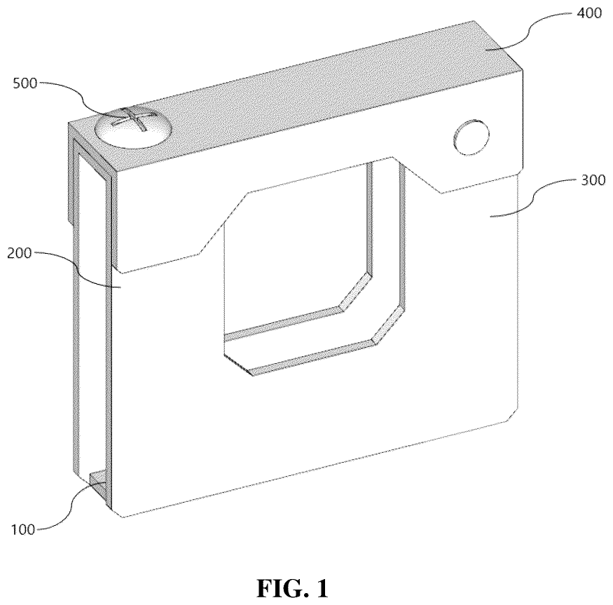

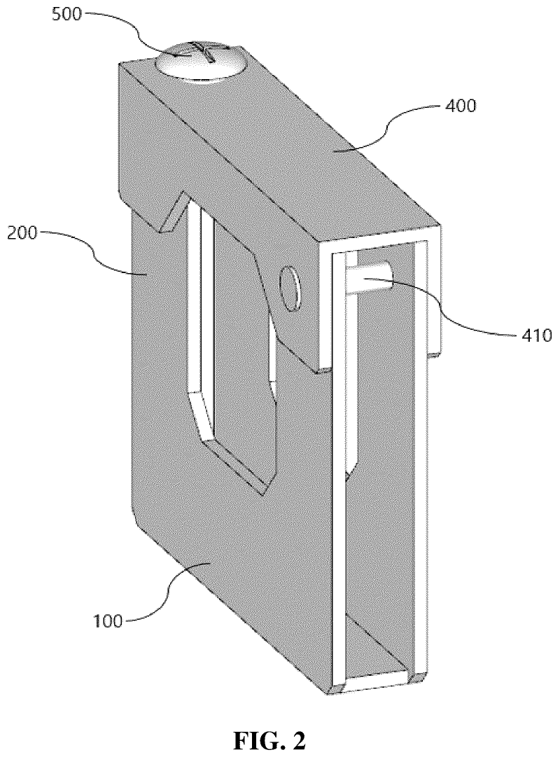

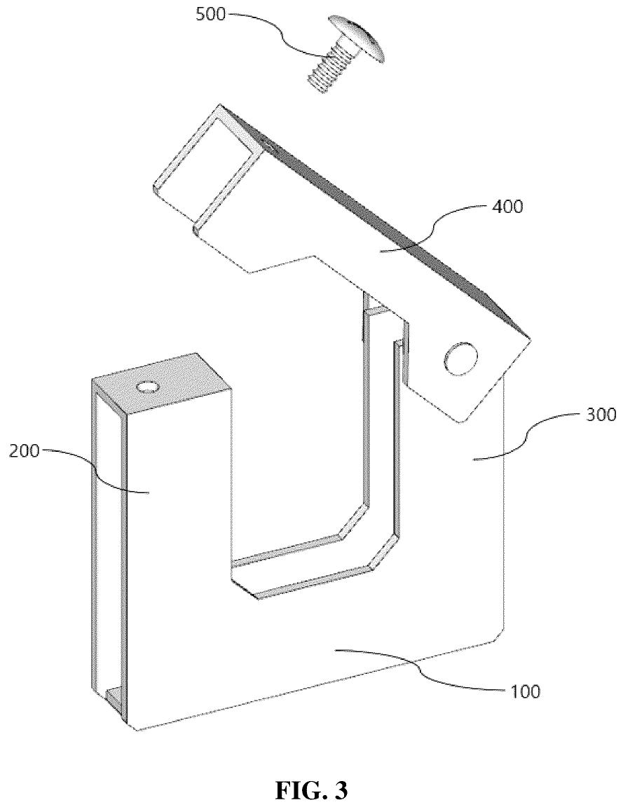

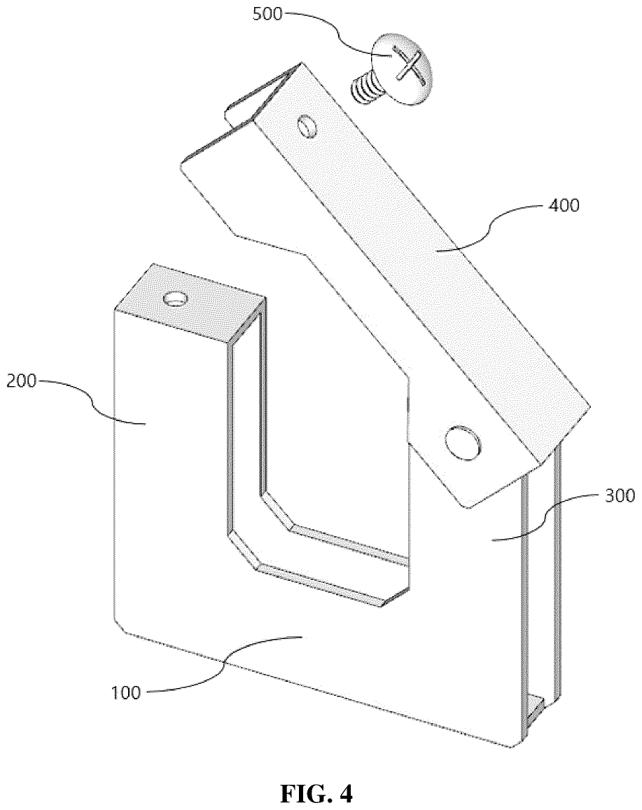

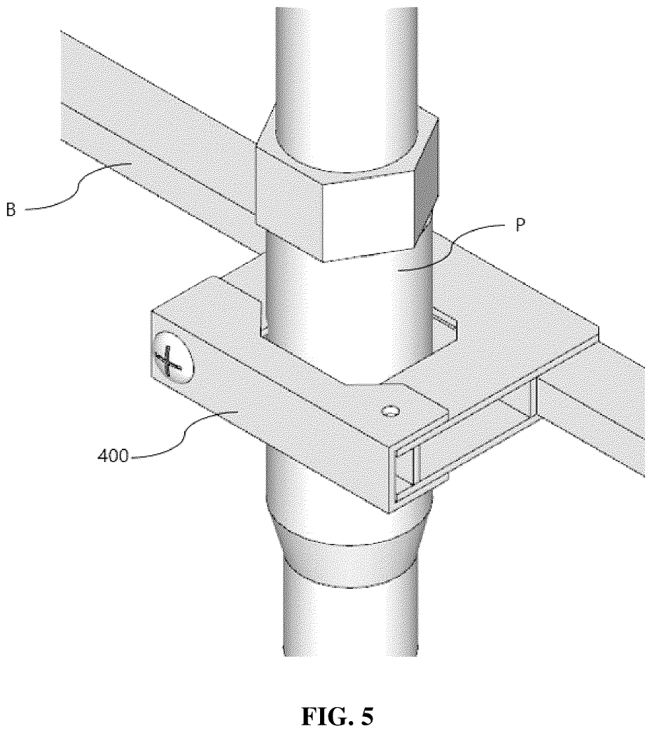

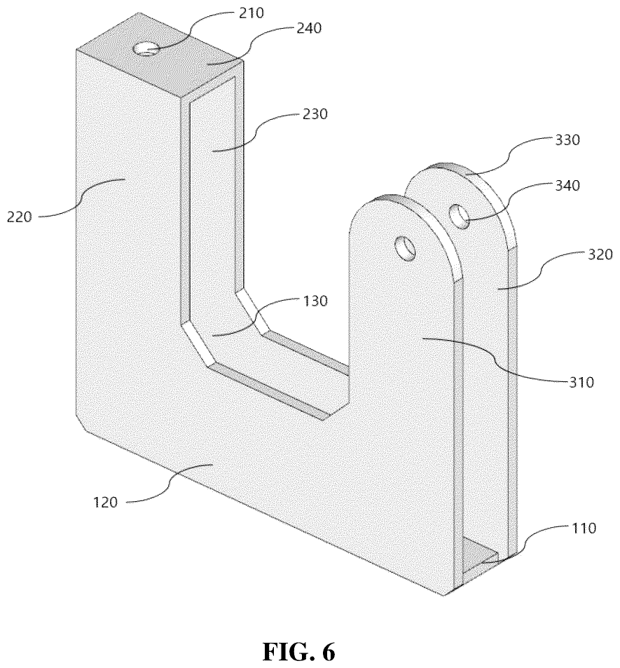

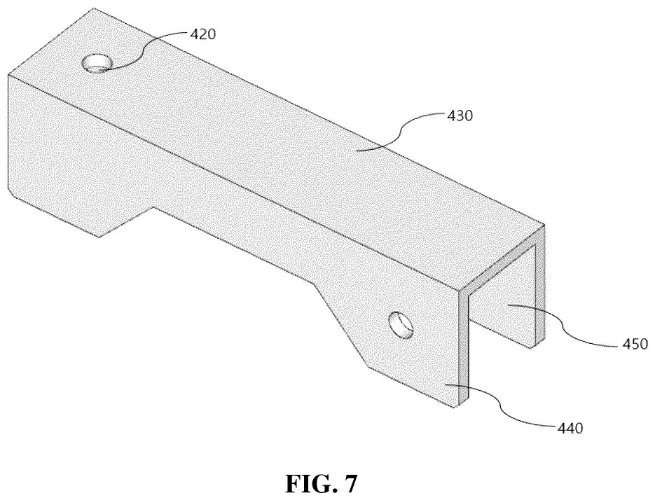

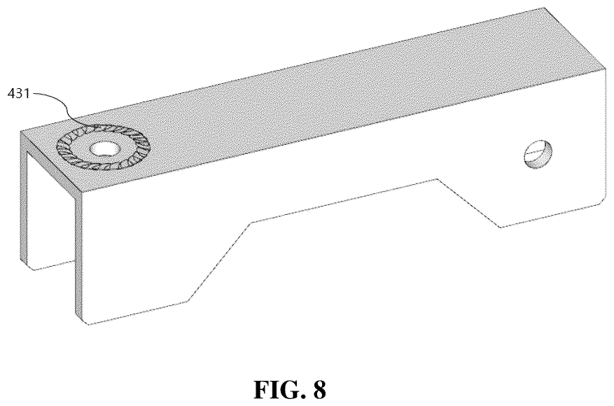

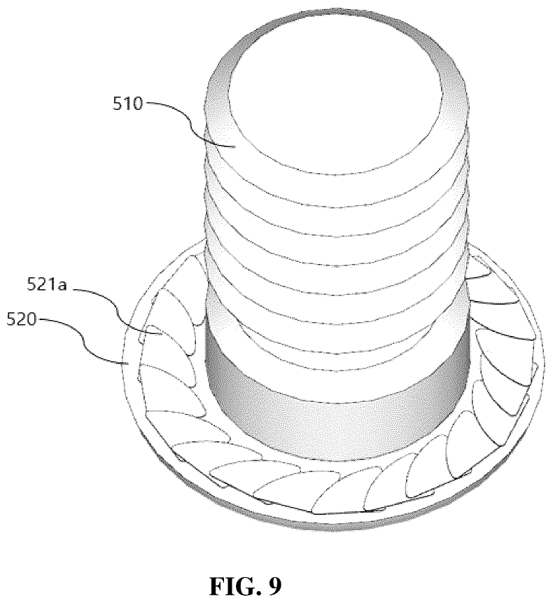

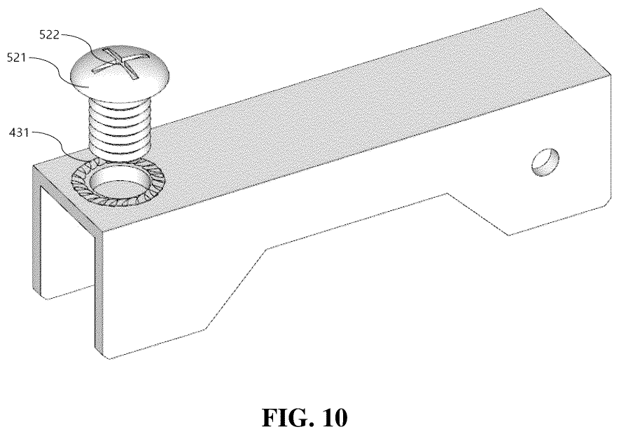

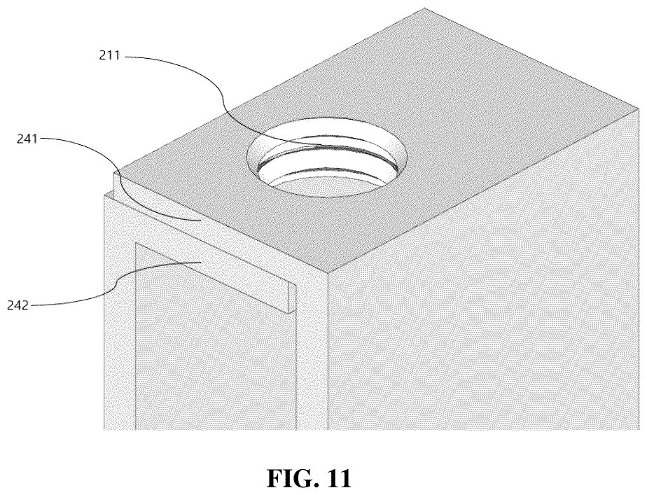

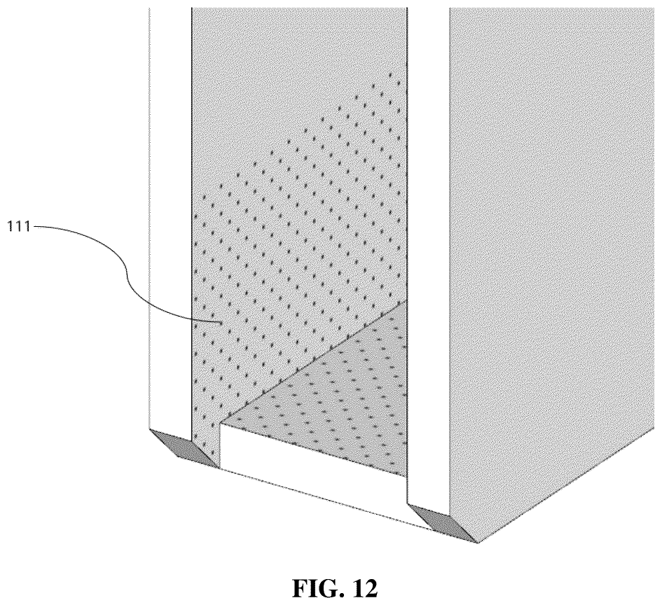

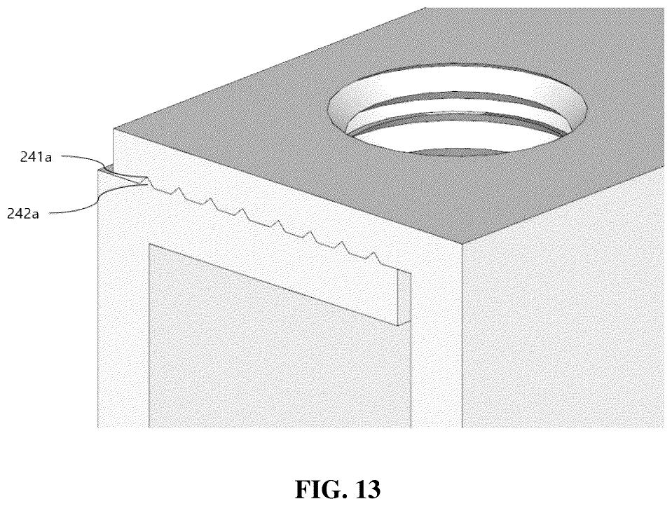

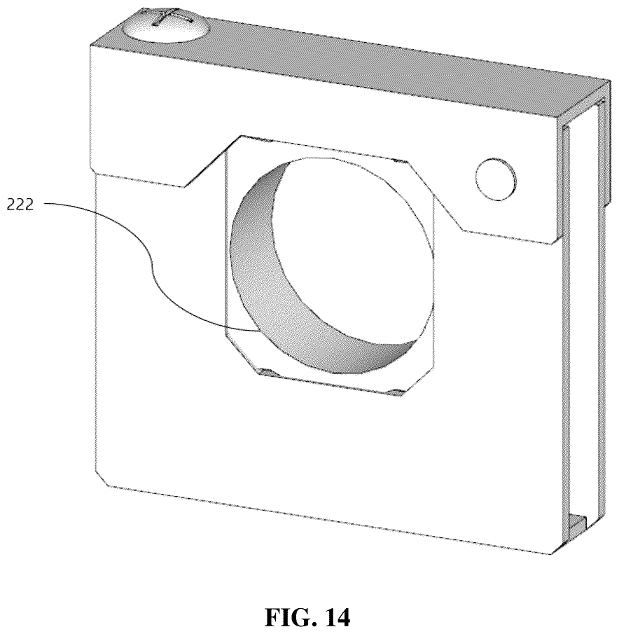

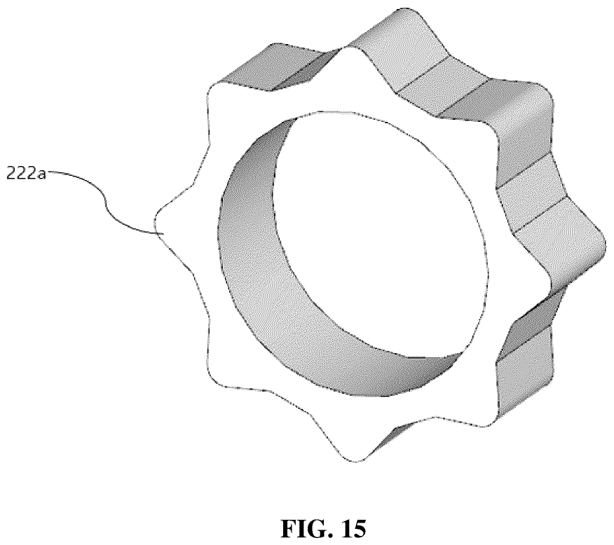

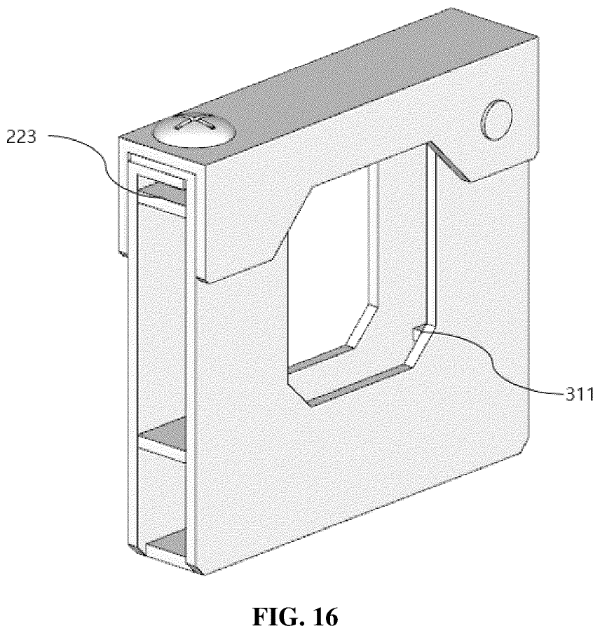

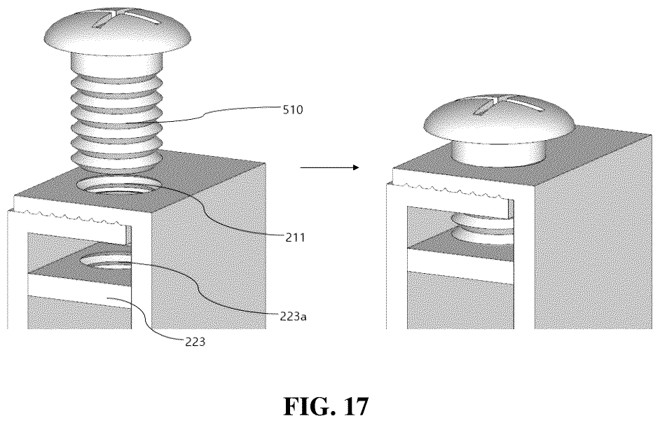

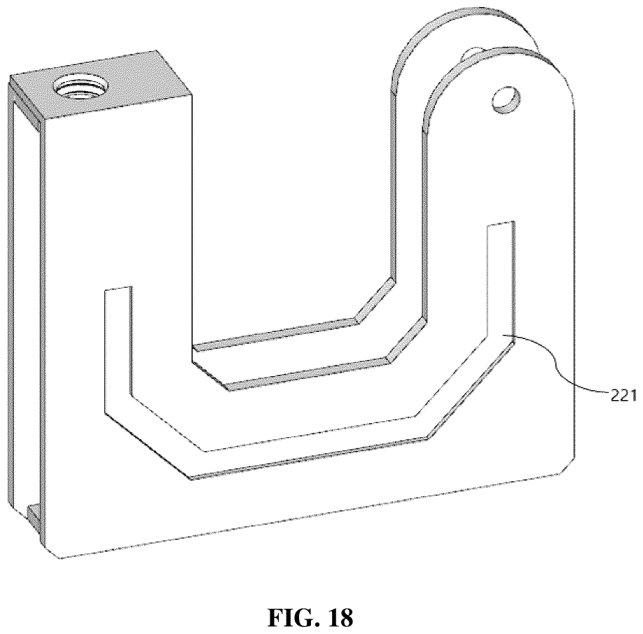

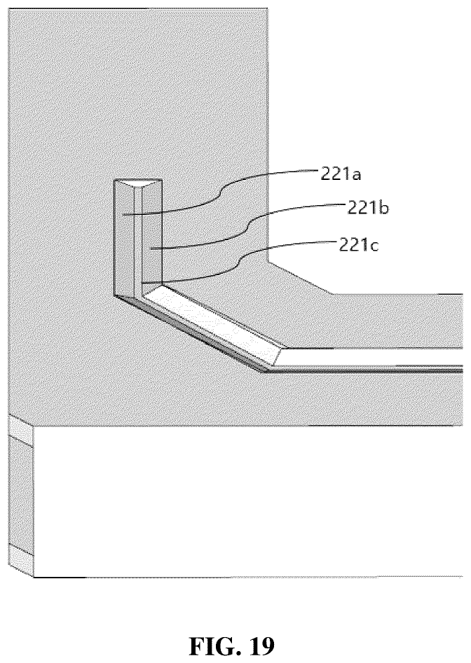

FIG. 1 to FIG. 5 are views showing the entire configuration of a center bracket for a sprinkler according to a preferred embodiment of the present disclosure, FIG. 6 to FIG. 10 are views showing in more detail the entire configuration of the center bracket for a sprinkler according to a preferred embodiment of the present disclosure, FIG. 11 to FIG. 13 are views showing in detail a front frame finish surface of the center bracket for a sprinkler according to a preferred embodiment of the present disclosure, FIG. 14 and FIG. 15 are views showing a shock-absorbing cap of the center bracket for a sprinkler according to a preferred embodiment of the present disclosure, FIG. 16 and FIG. 17 are views showing a plurality of threads of the center bracket for a sprinkler according to a preferred embodiment of the present disclosure, and FIG. 18 and FIG. 19 are views showing an assistant curved groove of the center bracket for a sprinkler according to a preferred embodiment of the present disclosure.

A center bracket for a sprinkler related to an embodiment of the present disclosure, first, has a base frame 100 configured to surround a first outer circumferential region that is ¼ region of 360° of the outer circumferential surface of a flexible pipe P for a sprinkler that surrounds a frame bar B on three surfaces along the length of the frame bar B, which is disposed in parallel with a ceiling to support the flexible pipe P having a cylindrical outer circumference, and is disposed perpendicularly to the length of the frame bar B.

Further, a front frame 200 protrudes forward further than the frame bar B from the front end of the base frame 100 and is configured to surround and support a second outer circumferential region of the flexible pipe P and a rear frame 300 protrudes forward further from the frame bar B from the rear end of the base frame 100, is disposed in parallel with the front frame 200, is configured to surround a third outer circumferential region facing the second outer circumferential region of the flexible pipe P in order to surround and fix the flexible pipe for a sprinkler to the frame bar.

In this configuration, a finish frame 400 is fixed to a rotary member 410 disposed at the end of the rear frame 300 and is configured to cover the portion between the front frame 200 and the rear frame 300 and surround a fourth outer circumferential region facing the first outer circumferential region of the flexible pipe P, and a fixing member 500 is configured such that the finish frame 400 is fixed to the front frame 200 through a second finish hole 420 formed at the end of the finish frame 400 and a first finish hole 210 formed at the front end of the front frame 200 in order to be supported on the frame bar in one direction and to support the flexible pipe from all 360 degrees at the front end of the frame bar.

In this configuration, the base frame 100 has a base bottom surface 110, and a first base wing surface 120 and a second base wing surface 130 facing each other up and down, and three surfaces of the frame bar B are in contact with the inner surfaces of the base bottom surface 110, the first base wing surface 120, and the second base wing surface 130 to support the flexible pipe at two upper and lower points, thereby increasing the supporting performance and reducing the weight of the bracket itself.

In this configuration, the front frame 200 is formed such that a first front frame surface 220 and a second front frame surface 230 formed by forward extension of the first base wing surface 120 and the second base wing surface 130 face each other, a front frame finish surface 240 is disposed ahead of the first and second front frame surfaces 220 and 230, and the first finish hole 210 is formed at the center of the front frame finish surface 240; and the rear frame 300 is formed such that a first rear frame surface 310 and a second rear frame surface 330 formed by forward extension of the first base wing surface 120 and the second base wing surface 130 face each other, rear frame curved lines 330 are formed at the ends of the first and second rear frame surfaces 310 and 320, and rotation through-holes 340 are formed at the first and second rear frame surfaces 310 and 320 adjacent to the rear frame curved lines 330 so that installation is easy and fixing force is maintained after installation.

Further, the finish frame 400 has a finish bottom surface 430 at the center to press a fourth outer circumferential region of the flexible pipe P by covering the portion between the front frame 200 and the rear frame 300 by rotating while surrounding the first and second front frame surfaces 220 and 230 and the first and rear frame surfaces 310 and 320, and a first finish surface 440 and a second finish surface 450 are disposed to face each other at the left and right sides of the finish bottom surface 430 such that the ends of the first and second finish surfaces 440 and 450 cover the sides of the first and second front frame surfaces 220 and 230 and the top of the front frame finish surface 240.

Meanwhile, the fixing member 500 is composed of a fixing body 510 that is inserted into the first and second finish holes 210 and 420 when the finish frame 400 is rotated and covers the top of the front frame finish surface 240, and a fixing head 520 that is connected to the top of the fixing body 510. Rotation extensions 521 are formed at the left and right of the fixing head 520, a driver-fixing center groove 522 is formed in a straight line shape or a cross shape at the center, a plurality of anti-rotation protrusions 521a is formed on the bottom of the fixing head 520, and a second anti-rotation fine friction portions 431 is formed on the finish bottom surface 430 that is in contact with the anti-rotation protrusion 521a, whereby installation is convenient and loosening after fixing is prevented.

In this configuration, fine friction surfaces 111 are formed on the inner surfaces of the first and second base wing surfaces 120 and 130 and the base bottom surface 110 of the base frame 100 and three surfaces of the frame bar B are in contact with the fine friction surfaces, whereby fastening force is increased and sliding is prevented.

Further, the front frame finish surface 240 having the first finish hole 210 has a first front finish surface 241 bending from the first front frame surface 220 and a second front finish surface 242 bending from the second front frame surface 230, and first threads 211 are formed on the inner circumferential surface of the first finish hole 210 to be thread-fastened with the fixing body 510.

In this configuration, the first front finish surface 241 and the second front finish surface 242 form layers by coming in contact with each other to increase the rigidity of the front frame 200, a fine accommodation groove 241a is formed at the lower end of the first front finish surface 241, and a fine accommodation protrusion 242a that is inserted in the fine accommodation groove 241a is further formed at the upper end of the second front finish surface 242, thereby maximizing the contact area of the first front finish surface 241 and the second front finish surface 242. As a result, it is possible to greatly improve the coupling force.

Meanwhile, assistant curved grooves 221 are formed at the center positions of the widths of the first and second front frame surfaces 220 and 230 and the first and rear frame surfaces 310 and 320 to prevent bending of the front and rear frames.

In this configuration, the assistant curved groove 221 has a first inclined surface 221a, a second inclined surface 221b having a shape that is left-right symmetric to the first inclined surface 221a, and a horizontal surface 221c connecting the first inclined surface 221 and the second inclined surface 221b to each other, thereby easily distributing force that is applied to the front and rear frames. As a result, there is an effect of further increasing the rigidity of the front and rear frames.

Further, a shock-absorbing cap 222 made of synthetic resin and curved in correspondence to the outer circumference of the flexible pipe P is disposed at a position where it is in contact with the base frame 110, the front frame 200, the rear frame 300, the finish frame 400, and the flexible pipe P and surrounds the first to fourth outer circumferential regions, and cap protrusions 222a are formed at the end of the shock-absorbing cap 222, thereby preventing damage to the flexible pipe due to vibration, etc. of the flexible pipe. The front frame 200 has an assistant front surface 223 coupling the first front frame surface 220 and the second front frame surface 230 to each other, and the rear frame 300 has an assistant rear surface 311 coupling the first rear frame surface 310 and the second rear frame surface 320 to each other to increase the strength for supporting the front and rear frames.

Further, second threads 223a are formed on the assistant front surfaces 223 and the end of the fixing body 510 is fastened thereto. Accordingly, an end of the fixing member 510 is fastened to the first threads 211 and the other end is fastened to the second threads 223a, whereby it is possible to greatly improve the coupling force and the strength.

By using the center bracket for a sprinkler of the present disclosure described above through an embodiment, a flexible pipe for a sprinkler is stably supported and protected, installation is easy, the reliability and durability of a sprinkler system are increased by maintaining the flexibility of a flexible pipe, the costs for maintenance are reduced, and stable performance is secured even in long-time use. A frame bar attached to a ceiling and a flexible pipe are made firm by: a base frame 100 that is configured to surround a first outer circumferential region that is ¼ region of 360° of the outer circumferential surface of a flexible pipe P for a sprinkler that surrounds a frame bar B on three surfaces along the length of the frame bar B, which is disposed in parallel with a ceiling to support the flexible pipe P having a cylindrical outer circumference, and is disposed perpendicularly to the length of the frame bar B; a front frame 200 that protrudes forward further than the frame bar B from the front end of the base frame 100 and is configured to surround and support a second outer circumferential region of the flexible pipe P; and a rear frame 300 that protrudes forward further from the frame bar B from the rear end of the base frame 100, is disposed in parallel with the front frame 200, is configured to surround a third outer circumferential region facing the second outer circumferential region of the flexible pipe P. Fixing and fastening are simply by: a finish frame 400 that is fixed to a rotary member 410 disposed at the end of the rear frame 300 and is configured to cover the portion between the front frame 200 and the rear frame 300 and surround a fourth outer circumferential region facing the first outer circumferential region of the flexible pipe P; and a fixing member 500 that is configured such that the finish frame 400 is fixed to the front frame 200 through a second finish hole 420 formed at the end of the finish frame 400 and a first finish hole 210 formed at the front end of the front frame 200. The base frame 100 has a base bottom surface 110, and a first base wing surface 120 and a second base wing surface 130 facing each other up and down, and three surfaces of the frame bar B are in contact with the inner surfaces of the base bottom surface 110, the first base wing surface 120, and the second base wing surface 130. The front frame 200 is formed such that a first front frame surface 220 and a second front frame surface 230 formed by forward extension of the first base wing surface 120 and the second base wing surface 130 face each other, a front frame finish surface 240 is disposed ahead of the first and second front frame surfaces 220 and 230, and the first finish hole 210 is formed at the center of the front frame finish surface 240; and the rear frame 300 is formed such that a first rear frame surface 310 and a second rear frame surface 330 formed by forward extension of the first base wing surface 120 and the second base wing surface 130 face each other, rear frame curved lines 330 are formed at the ends of the first and second rear frame surfaces 310 and 320, and rotation through-holes 340 are formed at the first and second rear frame surfaces 310 and 320 adjacent to the rear frame curved lines 330. The finish frame 400 has a finish bottom surface 430 at the center to press a fourth outer circumferential region of the flexible pipe P by covering the portion between the front frame 200 and the rear frame 300 by rotating while surrounding the first and second front frame surfaces 220 and 230 and the first and rear frame surfaces 310 and 320, and a first finish surface 440 and a second finish surface 450 are disposed to face each other at the left and right sides of the finish bottom surface 430 such that the ends of the first and second finish surfaces 440 and 450 cover the sides of the first and second front frame surfaces 220 and 230 and the top of the front frame finish surface 240, whereby resistance against vibration and shaking of a flexible pipe is increased. The fixing member 500 is composed of a fixing body 510 that is inserted into the first and second finish holes 210 and 420 when the finish frame 400 is rotated and covers the top of the front frame finish surface 240, and a fixing head 520 that is connected to the top of the fixing body 510. Rotation extensions 521 are formed at the left and right of the fixing head 520, a driver-fixing center groove 522 is formed in a straight line shape or a cross shape at the center, a plurality of anti-rotation protrusions 521a is formed on the bottom of the fixing head 520, and a second anti-rotation fine friction portions 431 is formed on the finish bottom surface 430 that is in contact with the anti-rotation protrusion 521a, whereby fixing-fastening force can be maintained long.

Preferred embodiments of the present disclosure were described above, but it would be understood by those skilled in the art that these embodiments described above are only examples of the spirit of the present disclosure and the present disclosure may be changed in various ways without departing from the spirit of the present disclosure. Accordingly, the protective range of the present disclosure should be construed by those described in claims rather than specific embodiments and all spirits within a corresponding range should also be construed as being included in the right range of the present disclosure.

What is claimed is:

1. A center bracket for a sprinkler, comprising:
a base frame configured to surround a first outer circumferential region that is ¼ region of 360° of an outer circumferential surface of a flexible pipe for a sprinkler that surrounds a frame bar on three surfaces along a length of the frame bar, which is disposed in parallel with a ceiling to support the flexible pipe having a cylindrical outer circumference, and is disposed perpendicularly to the length of the frame bar;
a front frame protruding forward further than the frame bar from a front end of the base frame and configured to surround and support a second outer circumferential region of the flexible pipe;
a rear frame protruding forward further from the frame bar from a rear end of the base frame, disposed in parallel with the front frame, configured to surround a third outer circumferential region facing the second outer circumferential region of the flexible pipe;
a finish frame fixed to a rotary member disposed at an end of the rear frame and configured to cover a portion between the front frame and the rear frame and surround a fourth outer circumferential region facing the first outer circumferential region of the flexible pipe; and
a fixing member configured such that the finish frame is fixed to the front frame through a second finish hole formed at an end of the finish frame and a first finish hole formed at the front end of the front frame.

2. The center bracket of claim 1, wherein the base frame has a base bottom surface, and a first base wing surface and a second base wing surface facing each other up and down, and three surfaces of the frame bar are in contact with inner surfaces of the base bottom surface, the first base wing surface, and the second base wing surface;
the front frame is formed such that a first front frame surface and a second front frame surface formed by forward extension of the first base wing surface and the second base wing surface face each other, a front frame finish surface is disposed ahead of the first and second front frame surfaces, and the first finish hole is formed at a center of the front frame finish surface;
the rear frame is formed such that a first rear frame surface and a second rear frame surface formed by forward extension of the first base wing surface and the second base wing surface face each other, rear frame curved lines are formed at ends of the first and second rear frame surfaces, and rotation through-holes are formed at the first and second rear frame surfaces adjacent to the rear frame curved lines; and
the finish frame has a finish bottom surface at a center to press a fourth outer circumferential region of the flexible pipe by covering the portion between the front frame and the rear frame by rotating while surrounding the first and second front frame surfaces and the first and rear frame surfaces, and a first finish surface and a second finish surface are disposed to face each other at left and right sides of the finish bottom surface such that ends of the first and second finish surfaces cover sides of the first and second front frame surfaces and a top of the front frame finish surface.

3. The center bracket of claim 2, wherein the fixing member has a fixing body that is inserted into the first and second finish holes when the finish frame is rotated and covers the top of the front frame finish surface, and a fixing head that is connected to a top of the fixing body; and
rotation extensions are formed at the left and right of the fixing head, a driver-fixing center groove is formed in a straight line shape or a cross shape at a center, a plurality of anti-rotation protrusions is formed on a bottom of the fixing head, and a second anti-rotation fine friction portions is formed on the finish bottom surface that is in contact with the anti-rotation protrusion.

4. The center bracket of claim 3, wherein fine friction surfaces are formed on the inner surfaces of the first and second base wing surfaces and the base bottom surface of the base frame and three surfaces of the frame bar are in contact with the fine friction surfaces;
the front frame finish surface having the first finish hole has a first front finish surface bending from the first front frame surface and a second front finish surface bending from the second front frame surface, and first threads are formed on an inner circumferential surface of the first finish hole to be thread-fastened with the fixing body; and
the first front finish surface and the second front finish surface form layers by coming in contact with each other to increase rigidity of the front frame, a fine accommodation groove is formed at a lower end of the first front finish surface, and a fine accommodation protrusion that is inserted in the fine accommodation groove is further formed at an upper end of the second front finish surface, thereby maximizing a contact area of the first front finish surface and the second front finish surface.

5. The center bracket of claim 4, wherein assistant curved grooves are formed at center positions of widths of the first and second front frame surfaces and the first and rear frame surfaces;
a shock-absorbing cap made of synthetic resin and curved in correspondence to an outer circumference of the flexible pipe is disposed at a position where the shock-absorbing cap is in contact with the base frame, the front frame, the rear frame, the finish frame, and the flexible pipe and surrounds the first to fourth outer circumferential regions, and cap protrusions are formed at an end of the shock-absorbing cap;
the front frame has an assistant front surface coupling the first front frame surface and the second front frame surface to each other, and the rear frame has an assistant rear surface coupling the first rear frame surface and the second rear frame surface to each other; and
second threads are formed on the assistant front surfaces and an end of the fixing body is fastened thereto, whereby an end of the fixing member is fastened to the first threads and the other end is fastened to the second threads.
